(19) United States
(12) Patent Application Publication
(10) Pub. No.: US 2026/0110430 A1
(43) Pub. Date: Apr. 23, 2026

(54) COMBUSTION TOOL

(71) Applicant: Illinois Tool Works Inc., Glenview, IL (US)

(72) Inventors: Olivier BAUDRAND, Beaumont-lès-Valence (FR); Kevin BOUBEKEUR, Bourg-Les-Valences (FR)

(21) Appl. No.: 19/365,881

(22) Filed: Oct. 22, 2025

(30) Foreign Application Priority Data
Oct. 23, 2024 (FR) 2411548
Sep. 22, 2025 (EP) 25203622.3

(51) Int. Cl. F23K 5/22; B25C 1/10; F23K 5/20

(52) U.S. Cl. CPC F23K 5/22; B25C 1/10; F23K 5/20; F23K 2300/204; F23K 2300/205

(57) ABSTRACT

A vaporizer for a combustion tool comprising an inlet, an outlet, a first pressure regulator fluidly connected to the inlet, a second pressure regulator fluidly connected to the outlet, and an evaporator fluidly connected between the first pressure regulator and the second pressure regulator. The vaporizer is configured to receive, when in use, liquid and/or gaseous fuel from a fuel cartridge on the combustion tool through the inlet so that it goes through the first pressure regulator, then through the evaporator, and then through the second pressure regulator so that the gaseous fuel is delivered through the outlet at a substantially constant pressure.

### PRIORITY CLAIM

This patent application claims priority to and the benefit of French Patent Application No. 2411548, filed Oct. 23, 2024, and European Patent Application No. 25203622.3, filed Sep. 22, 2025, the entire contents of each of which are incorporated herein by reference.

### TECHNICAL FIELD

The present disclosure generally relates to combustion tools, and in particular a fuel delivery system for combustion tools. More specifically, though not exclusively, the present disclosure relates to a fuel delivery system for combustion tools comprising a vaporizer.

### TECHNICAL BACKGROUND

Fuel delivery systems for combustion tools normally comprise a pressurized gaseous fuel cartridge coupled to a metering mechanism for delivering a preset amount of pressurized gaseous fuel to the combustion chamber.

### SUMMARY

The present disclosure aims to provide a more versatile fuel delivery system in which a wider variety of fuels can be used.

The present disclosure relates to a vaporizer for a combustion tool, the vaporizer comprising an evaporator for vaporizing a liquid and/or gaseous fuel and at least one pressure regulator for delivering the vaporized fuel at a substantially constant pressure.

The vaporizer can comprise an inlet. The vaporizer can comprise an outlet. The vaporizer can comprise a first pressure regulator, which can be connected, for example fluidly, to the inlet. The vaporizer can comprise a second pressure regulator, which can be connected, for example fluidly, to the outlet. The evaporator can be fluidly connected to the first and/or to the second pressure regulator. The evaporator can be fluidly connected between the first and the second pressure regulator.

The vaporizer can be configured to receive, when in use, liquid and/or gaseous fuel, for example from a fuel cartridge on the combustion tool, through the inlet. The vaporizer can be configured to receive liquid and/or gaseous fuel through the inlet so that it goes through the first pressure regulator, and/or through the evaporator and/or through the second pressure regulator, for example, so that the gaseous fuel is delivered through the outlet at a substantially constant pressure.

The present disclosure also relates to a vaporizer for a combustion tool, the vaporizer comprising: an inlet; an outlet; a first pressure regulator fluidly connected to the inlet; a second pressure regulator fluidly connected to the outlet; and an evaporator fluidly connected between the first pressure regulator and the second pressure regulator; in which the vaporizer is configured to receive, when in use, liquid and/or gaseous fuel from a fuel cartridge on the combustion tool through the inlet so that it goes through the first pressure regulator, then through the evaporator, and then through the second pressure regulator so that the gaseous fuel is delivered through the outlet at a substantially constant pressure.

The inventors found that having two pressure regulators and an evaporator between them can ensure that liquid and/or gaseous fuel received from a fuel cartridge, in which the delivery pressure can vary considerably, is delivered to the evaporator at a substantially constant pressure, while also ensuring that the vaporized fuel is also delivered to the combustion chamber at a substantially constant pressure.

The evaporator can comprise a heat exchanger. The heat exchanger can be configured to heat, for example selectively heat, the liquid and/or gaseous fuel flowing through it.

More specifically, the evaporator can comprise a heat exchanger configured to selectively heat the liquid and/or gaseous fuel flowing through it.

The evaporator can comprise a heating mechanism for heating the heat exchanger.

The heat exchanger can comprise a tortuous flow path through which the liquid and/or gaseous fuel flows.

Tortuous flow enables the liquid to be captured inside the evaporator as it changes direction, maximizing its chances of evaporation.

The tortuous flow path can have a spiral or serpentine shape.

This allows the liquid to flow over a longer distance, maximizing its chances of evaporation while minimizing space requirements.

The evaporator and/or heat exchanger can comprise an inlet and/or an outlet. The evaporator and/or heat exchanger can be substantially cylindrical. The tortuous flow path can be formed in one side of the evaporator or heat exchanger, for example one of its axial sides.

A radially outer end of the tortuous flow path can form or be fluidly connected to the inlet or outlet of the evaporator or heat exchanger. A radially innermost end of the tortuous flow path can form or be fluidly connected to the inlet or outlet of the evaporator or heat exchanger.

According to at least one embodiment of the present disclosure, the fuel delivery system according to the present disclosure comprises a fuel cartridge fluidly connected to the inlet to deliver liquid and/or gaseous fuel contained in the fuel cartridge to the fuel delivery system.

The evaporator and/or heat exchanger can comprise a radial hole that can form the inlet or outlet of the evaporator or heat exchanger.

The first pressure regulator can be configured to deliver liquid and/or gaseous fuel, for example to an evaporator inlet, at a first preset pressure, which can be substantially constant.

The second pressure regulator can be configured to deliver gaseous fuel, for example to the outlet, at a second preset pressure, which can be substantially constant.

More specifically, the first pressure regulator can be configured to deliver liquid and/or gaseous fuel to an inlet on the evaporator at a first preset, substantially constant pressure, with the second pressure regulator being configured to deliver gaseous fuel to the outlet at a second preset, substantially constant pressure.

The evaporator can be configured to increase the pressure of the liquid and/or gaseous fuel as it flows through it.

The first preset pressure can be substantially equal to the second preset pressure.

The first preset pressure can be lower than the second preset pressure.

The first preset pressure can be higher than the second preset pressure.

The inlet can be provided by a fluid connection. The first pressure regulator can comprise an inlet feed. The fluid connection can be coupled, for example by a threaded connector, to the inlet feed on the first pressure regulator. The first pressure regulator can comprise an inlet chamber. The inlet feed on the first pressure regulator can lead to the inlet chamber.

The first pressure regulator can comprise an outlet feed. The inlet chamber on the first pressure regulator can be connected, for example fluidly, to the outlet feed via a pressure reducer. The outlet feed on the first pressure regulator can be connected, for example fluidly, to the evaporator. The inlet on the evaporator or heat exchanger can be connected, for example fluidly, to the outlet feed on the first pressure regulator.

The pressure reducer on the first pressure regulator can be configured to control pressurized liquid and/or gaseous fuel delivered to the inlet chamber on the first pressure regulator, ensuring, for example, that the pressurized liquid and/or gaseous fuel is delivered to the evaporator at a substantially constant first pressure.

The first pressure regulator can comprise an adjustment mechanism, such as a pressure adjustment screw. The pressure adjustment mechanism on the first pressure regulator can be used to adjust the pressure reducer, for example to set the substantially constant first pressure. The pressure adjustment mechanism on the first pressure regulator can be actuated by an automatic setting mechanism.

The second pressure regulator can comprise an inlet feed. The outlet on the evaporator or heat exchanger can be connected, for example fluidly, to the inlet feed on the second pressure regulator. The second pressure regulator can comprise an inlet chamber. The inlet feed on the second pressure regulator can lead to the inlet chamber.

The second pressure regulator can comprise an outlet feed. The inlet chamber on the second pressure regulator can be connected, for example fluidly, to the outlet feed via a pressure reducer. The outlet feed on the second pressure regulator can be connected, for example fluidly, to the outlet. The outlet can be provided by a fluid connection. The fluid connection can be coupled, for example by a threaded connector, to the outlet feed on the second pressure regulator.

The pressure reducer on the second pressure regulator can be configured to control pressurized gaseous fuel delivered to the inlet chamber on the second pressure regulator, ensuring, for example, that the pressurized gaseous fuel is delivered to the outlet at a substantially constant second pressure.

The second pressure regulator can comprise an adjustment mechanism, such as a pressure adjustment screw. The pressure adjustment mechanism on the second pressure regulator can be used to adjust the pressure reducer, for example to set the substantially constant first pressure. The pressure adjustment mechanism on the second pressure regulator can be actuated by an automatic setting mechanism.

The present disclosure also relates to a fuel delivery system. The system can comprise a vaporizer, for example a vaporizer as described above.

The system can comprise a metering mechanism. The metering mechanism can be connected, for example fluidly, to the vaporizer. The metering mechanism can be used to deliver a measured amount of gaseous fuel, for example at a preset pressure, to a combustion chamber on a combustion tool.

The present disclosure also relates to a fuel delivery system comprising a vaporizer as described above and a metering mechanism fluidly connected to the vaporizer and used to deliver a measured amount of gaseous fuel at a preset pressure to a combustion chamber on a combustion tool.

The metering mechanism can comprise a metering device. The metering device can comprise an inlet and/or an outlet. The metering device inlet can be connected, for example fluidly, to the vaporizer outlet. The outlet on the metering device can be coupled, for example by fluid coupling, to a combustion chamber on a combustion tool.

The system can comprise a fuel cartridge. The fuel cartridge can be connected, for example fluidly, to the vaporizer to deliver liquid and/or gaseous fuel contained in the fuel cartridge to the vaporizer.

More specifically, the system can comprise a fuel cartridge fluidly connected to the vaporizer to deliver liquid and/or gaseous fuel contained in the fuel cartridge to the vaporizer.

The fuel cartridge can comprise a bagless fuel cartridge.

The present disclosure also relates to a combustion tool. The combustion tool can comprise a fuel delivery system, for example a fuel delivery system as described above. The combustion tool can comprise a combustion chamber connected, for example fluidly, to the fuel delivery system.

The present disclosure also relates to a combustion tool comprising a fuel delivery system as described above and a combustion chamber fluidly connected thereto.

The combustion tool can comprise a driving tool for driving a fastener into a substrate.

The combustion tool can comprise a nailer or a stapler.

In order to avoid any doubt, all the features described herein also apply to any aspect of the present disclosure.

In order to avoid any ambiguity, the terms “can,” “and/or,” “for example,” and any other similar term used in the present document are to be interpreted as not limiting, such that any feature thus described is not necessarily required to be present.

### BRIEF DESCRIPTION OF THE SEVERAL VIEWS OF THE FIGURES

Other features and advantages of the present disclosure will become apparent from the following detailed description, which will be understood in reference to the appended drawings.

FIG. 1 illustrates a cross-sectional view of a vaporizer according to one example embodiment of the present disclosure.

FIG. 2 illustrates a perspective view of the vaporizer in FIG. 1.

FIG. 3 illustrates a perspective view of the evaporator in the vaporizer in FIGS. 1 and 2.

FIG. 4 illustrates a diagram of a combustion tool comprising the vaporizer in FIGS. 1, 2, and 3.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

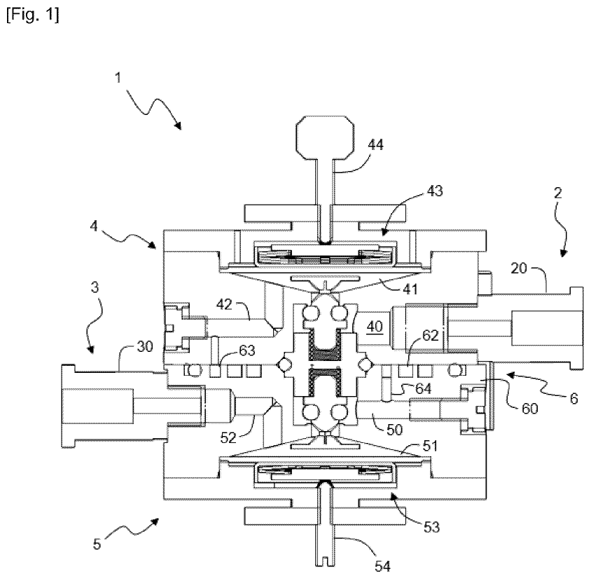

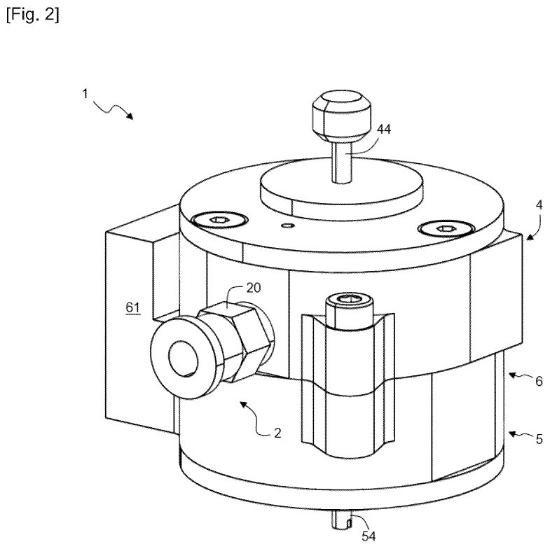

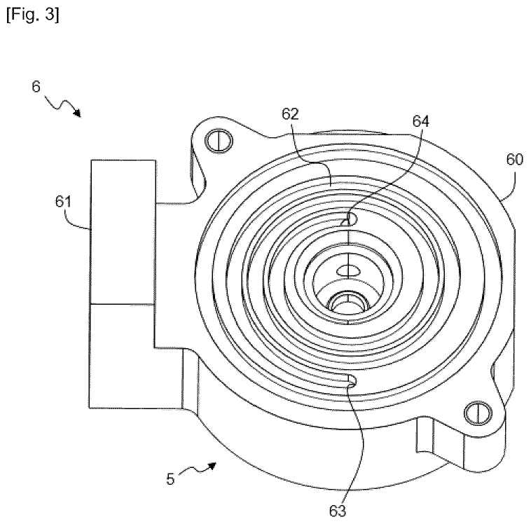

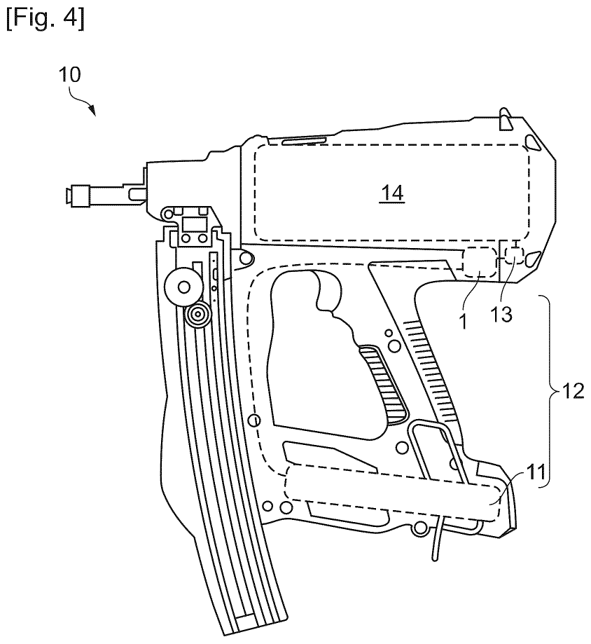

Referring now to FIGS. 1, 2, and 3, a vaporizer 1 for a combustion tool 10 (illustrated in FIG. 4) can be seen. The vaporizer 1 comprises an inlet 2, an outlet 3, a first pressure regulator 4 fluidly connected to the inlet 2, a second pressure regulator 5 fluidly connected to the outlet 3, and an evaporator 6 fluidly connected between the first pressure regulator 4 and the second pressure regulator 5.

The vaporizer 1 provides a flow path for the fuel that runs from the inlet 2, through the first pressure regulator 4, then through the evaporator 6, and finally through the second pressure regulator 5, before exiting through the outlet port 3. The fuel received by the inlet 2 is thus set to a first preset and substantially constant pressure by the first pressure regulator 4 before entering the evaporator 6, while the vaporized fuel is set to a second preset and substantially constant pressure by the second pressure regulator 5 before exiting through the outlet port 3.

In this example, the inlet 2 is provided by a fluid connection 20, which is coupled by a threaded connector to an inlet feed 40 on the first pressure regulator 4. The inlet feed 40 on the first pressure regulator 4 leads to an inlet chamber 41, which is fluidly connected to an outlet feed 42 by a pressure reducer 43. The outlet feed 42 is fluidly connected to the evaporator 6.

The pressure reducer 43 on the first pressure regulator 4 is configured to control pressurized liquid and/or gaseous fuel that is delivered to the inlet chamber 41 in the usual manner. This ensures that the pressurized liquid and/or gaseous fuel is delivered to the evaporator 6 at a substantially constant first pressure.

The first pressure regulator 4 also comprises a pressure adjustment screw 44, which can be used to adjust the pressure reducer 43 to set the first substantially constant pressure. The pressure adjustment screw 44 can be actuated by an automatic setting mechanism (not shown).

In this example, the evaporator 6 comprises a heat exchanger 60 and a heating mechanism 61 for selectively heating the liquid and/or gaseous fuel flowing through it. The heat exchanger 60 comprises a tortuous flow path 62 through which the liquid and/or gaseous fuel flows. The tortuous flow path 62 has a spiral or serpentine shape.

The heat exchanger 60 is substantially cylindrical and the tortuous flow path 62 is formed in one of its axial sides. A radially outer end of the tortuous flow path 62 forms an inlet 63 on the evaporator 6, which is fluidly connected to an outlet feed 42 on the first pressure regulator 4. A radially innermost end of the tortuous flow path 62 comprises a radial hole that forms an outlet 64 on the evaporator 6, which is fluidly connected to an inlet feed 50 on the second pressure regulator 5.

The inlet feed 50 on the second pressure regulator 5 leads to an inlet chamber 51, which is fluidly connected to an outlet feed 52 by a pressure reducer 53. In this example, the outlet 3 is provided by a fluid connection 30, which is coupled by a threaded connector to the outlet feed 52 on the second pressure regulator 5.

The pressure reducer 53 on the second pressure regulator 5 is configured to control the pressurized gaseous fuel vaporized by the evaporator 6 and delivered to the inlet chamber 51 in the usual manner. This ensures that the pressurized liquid and/or gaseous fuel is delivered to the outlet 3 at a second, substantially constant pressure.

The second pressure regulator 5 also comprises a pressure adjustment screw 54, which can be used to adjust the pressure reducer 53 on the second pressure regulator 5 to set the second substantially constant pressure. The pressure adjustment screw 54 can also be actuated by an automatic setting mechanism (not shown).

The vaporizer 1 is thus configured to receive, when in use, pressurized liquid and/or gaseous fuel through the inlet 2 so that it goes through the first pressure regulator 4, then through the evaporator 6, and then through the second pressure regulator 5 so that the gaseous fuel is delivered through the outlet 3 at a substantially constant pressure.

By heating the pressurized liquid and/or gaseous fuel, the evaporator 6 increases the pressure of the fuel as it flows through. In some cases, the first preset pressure can be substantially equal to the second preset pressure. In other cases, the first preset pressure can be lower than the second preset pressure. In yet other cases, the first preset pressure can be greater than the second preset pressure.

The person skilled in the art will understand that the pressure reducers 43, 53 on the first and second pressure regulators 4, 5 can be set to suit any particular fuel using the pressure adjustment screws 44, 54. In the embodiments in which this setting is automated, this operation can be carried out automatically.

Referring now to FIG. 4, a combustion tool 10 can be seen. The combustion tool 10 comprises a fuel cartridge 11 and a fuel delivery system 12 fluidly connected to the fuel cartridge 11.

The fuel delivery system 12 comprises the vaporizer 1 and a metering mechanism 13 fluidly connected to the vaporizer 1. The metering mechanism 13 is used to deliver a measured amount of gaseous fuel at a preset pressure to a combustion chamber 14 on the combustion tool 10.

In this example, the combustion tool 10 comprises a driving tool for driving a fastener into a substrate. More specifically, the combustion tool 10 comprises a self-contained combustion nailer.

The person skilled in the art will understand that the embodiments described above can vary in many ways.

### LIST OF REFERENCE NUMBERS

1 vaporizer
10 combustion tool
11 fuel cartridge
12 fuel delivery system
13 metering mechanism
14 combustion chamber
2 vaporizer inlet
20 liquid inlet connection
3 vaporizer outlet
30 liquid outlet connection
4 first pressure regulator
40 first pressure regulator inlet feed
41 first pressure regulator inlet chamber
42 first pressure regulator outlet feed
43 pressure reducer on the first pressure regulator
44 pressure adjustment screw on the first pressure regulator
5 second pressure regulator
50 second pressure regulator inlet feed
51 second pressure regulator inlet chamber
52 second pressure regulator outlet feed
53 pressure reducer on the second pressure regulator
54 pressure adjustment screw on the second pressure regulator
6 evaporator
60 heat exchanger
61 heating mechanism
62 tortuous flow path
63 evaporator inlet
64 evaporator outlet

1. A vaporizer for a combustion tool, the vaporizer comprising:
an inlet;
an outlet;
a first pressure regulator fluidly connected to the inlet;
a second pressure regulator fluidly connected to the outlet; and
an evaporator fluidly connected between the first pressure regulator and the second pressure regulator,
wherein the vaporizer is configured to receive, when in use, fuel from a fuel cartridge on the combustion tool through the inlet so that fuel goes through the first pressure regulator, then through the evaporator, and then through the second pressure regulator so that the fuel is delivered through the outlet at a substantially constant pressure.

2. The vaporizer of claim 1, wherein the evaporator includes a heat exchanger configured to selectively heat the fuel flowing through the heat exchanger.

3. The vaporizer of claim 2, wherein the evaporator includes a heating mechanism positioned to heat the heat exchanger.

4. The vaporizer of claim 2, wherein the heat exchanger defines a tortuous flow path through which the fuel can flow.

5. The vaporizer of claim 4, wherein the tortuous flow path has one of a spiral shape and a serpentine shape.

6. The vaporizer of claim 2, wherein the first pressure regulator is configured to deliver fuel to an inlet on the evaporator at a first preset substantially constant pressure, and the second pressure regulator is configured to deliver gaseous fuel to the outlet at the substantially constant pressure which is a second preset substantially constant pressure.

7. The vaporizer of claim 6, wherein the evaporator is configured to increase pressure of the fuel as the fuel flows through the evaporator.

8. The vaporizer of claim 6, wherein the first preset substantially constant pressure is substantially equal to the second preset substantially constant pressure.

9. The vaporizer of claim 6, wherein the first preset substantially constant pressure is lower than the second preset substantially constant pressure.

10. The vaporizer of claim 6, wherein the first preset substantially constant pressure is higher than the second preset substantially constant pressure.

11. A fuel delivery system for a combustion tool, said fuel delivery system comprising:
a vaporizer including:
an inlet;
an outlet;
a first pressure regulator fluidly connected to the inlet;
a second pressure regulator fluidly connected to the outlet; and
an evaporator fluidly connected between the first pressure regulator and the second pressure regulator,
wherein the vaporizer is configured to receive, when in use, fuel from a fuel cartridge on the combustion tool through the inlet so that fuel goes through the first pressure regulator, then through the evaporator, and then through the second pressure regulator so that the fuel is delivered through the outlet at a substantially constant pressure.

12. The fuel delivery system according to claim 11, which includes a fuel cartridge fluidly connected to the inlet to supply fuel contained in the fuel cartridge to the vaporizer.

13. A combustion tool comprising:
a fuel delivery system comprising a vaporizer including:
an inlet;
an outlet;
a first pressure regulator fluidly connected to the inlet;
a second pressure regulator fluidly connected to the outlet; and
an evaporator fluidly connected between the first pressure regulator and the second pressure regulator,
wherein the vaporizer is configured to receive, when in use, fuel from a fuel cartridge on the combustion tool through the inlet so that fuel goes through the first pressure regulator, then through the evaporator, and then through the second pressure regulator so that the fuel is delivered through the outlet at a substantially constant pressure.

14. The combustion tool of claim 13, which comprises a nailer or a stapler.
